(19) United States
(12) Patent Application Publication
(10) Pub. No.: US 2025/0044966 A1
(43) Pub. Date: Feb. 6, 2025

(54) MULTIPLE MEMORY PERFORMANCE STATES USING SYSTEM MEMORY

(71) Applicants: Advanced Micro Devices, Inc., Santa Clara, CA (US); ATI Technologies ULC, Markham (CA)

(72) Inventors: Nicholas Carmine DeFiore, Austin, TX (US); Sridhar Varadharajulu Gada, Austin, TX (US); James R. Magro, Austin, TX (US); Michael L. Choate, Austin, TX (US); Wayne Paul Rodrigue, Austin, TX (US); NrusimhaVamsi Krishna Godavarti, Austin, TX (US); Robert Gentile, Austin, TX (US); Roozbeh Paribakht, Markham (CA); Anwar Kashem, Boxborough, MA (US)

(73) Assignees: Advanced Micro Devices, Inc., Santa Clara, CA (US); ATI Technologies ULC, Markham, ON (CA)

(21) Appl. No.: 18/362,796

(22) Filed: Jul. 31, 2023

(51) Int. Cl. G06F 3/06

(52) U.S. Cl. CPC G06F 3/0634; G06F 3/0604; G06F 3/0656; G06F 3/0673

(57) ABSTRACT

The disclosed device includes a cache that stores sets of settings for memory states, and registers that store a current set of settings for a memory. The device also includes a control circuit that can read, from the cache in response to the memory transitioning to a new memory state, a new set of settings corresponding to the new memory state, and write, to the plurality of registers, the new set of settings. Various other methods, systems, and computer-readable media are also disclosed.

### BACKGROUND

Memory devices can operate at various frequencies for different levels of performance (e.g., memory performance states). Thus, operating at higher frequencies can achieve higher memory bandwidths for increased performance. However, certain signal losses and/or distortions can occur at certain frequencies, particularly at higher frequencies. Various equalization techniques can improve signal integrity at such higher frequencies. However, such techniques are not trivial to implement and therefore can be limited to a specific memory performance state.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for multiple memory performance states using system memory.

FIG. 2 is a block diagram of an exemplary system for multiple memory performance states using system memory.

FIG. 3 is a flow diagram of an exemplary method for multiple memory performance states using system memory.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to multiple memory performance states using system memory. As will be explained in greater detail below, implementations of the present disclosure utilize system memory (e.g., a processor cache) for storing multiple sets of settings for configuring memory states. The systems and methods described herein can swap out the sets of settings into a limited register space of a memory device allowing the memory device to effectively transition to a new memory state with the settings.

In one implementation, a device for multiple memory performance states using system memory includes a cache configured to store a plurality of sets of settings for memory, each set corresponding to a memory state and a plurality of registers configured to store a current set of settings for the memory. The device also includes a control circuit configured to read, from the cache in response to the memory transitioning to a new memory state, a new set of settings corresponding to the new memory state, and write, to the plurality of registers, the new set of settings.

In some examples, each memory state corresponds to a memory frequency and each of the plurality of sets of settings includes frequency-dependent settings. In some examples, the frequency-dependent settings correspond to at least one of noise compensation settings, voltage settings, or timing settings. In some examples, the noise compensation settings are tuned during a boot sequence of the device.

In some examples, a transition sequence for transitioning to the new memory state includes a self-refresh operation and the control circuit is configured to write the new set of settings to the plurality of registers before the self-refresh operation initiates.

In some examples, writing the new set of settings comprises selectively writing the new set of settings. In some examples, selectively writing the new set of settings includes writing updated settings to corresponding registers of the plurality of registers for settings of the current set of settings that require updating for the new set of settings. In some examples, selectively writing the new set of settings further includes maintaining registers of the plurality of registers corresponding to settings that are not updated.

In one implementation, a system for multiple memory performance states using system memory includes a memory, a plurality of registers configured to store a current set of settings for the memory, and a processor including a cache configured to store a plurality of sets of settings for the memory, each set corresponding to a memory state. The system also includes a control circuit configured to receive an indication of a transition sequence of the memory to a new memory state, read, from the cache in response initiating the transition sequence, a new set of settings corresponding to the new memory state, and write, to the plurality of registers, the new set of settings.

In some examples, each memory state corresponds to a memory frequency and each of the plurality of sets of settings includes frequency-dependent settings. In some examples, the frequency-dependent settings correspond to at least one of noise compensation settings, voltage settings, or timing settings. In some examples, the noise compensation settings are tuned during a boot sequence of the system.

In some examples, the transition sequence includes a self-refresh operation, and the control circuit is configured to write the new set of settings to the plurality of registers before the self-refresh operation initiates. In some examples, the control circuit is configured to initiate the transition sequence in response to a power management decision. In some examples, the plurality of registers corresponds to memory channel registers.

In some examples, writing the new set of settings comprises selectively writing the new set of settings. In some examples, selectively writing the new set of settings includes writing updated settings to corresponding registers of the plurality of registers for settings of the current set of settings that require updating for the new set of settings. In some examples, selectively writing the new set of settings further comprises maintaining registers of the plurality of registers corresponding to settings that are not updated.

In one implementation, a method for multiple memory performance states using system memory includes (i) initiating a transition sequence of a memory from a current memory state to a new memory state, (ii) reading, from a processor cache configured to store a plurality of sets of settings for the memory and each set corresponding to a memory state, a new set of settings corresponding to the new memory state, and (iii) writing, to a plurality of memory channel registers configured to store a current set of settings for the memory, the new set of settings.

In some examples, the method includes writing the new set of settings to the plurality of memory channel registers before a self-refresh operation of the transition sequence initiates.

Features from any of the implementations described herein can be used in combination with one another in accordance with the general principles described herein. These and other implementations, features, and advantages will be more fully understood upon reading the following detailed description in conjunction with the accompanying drawings and claims.

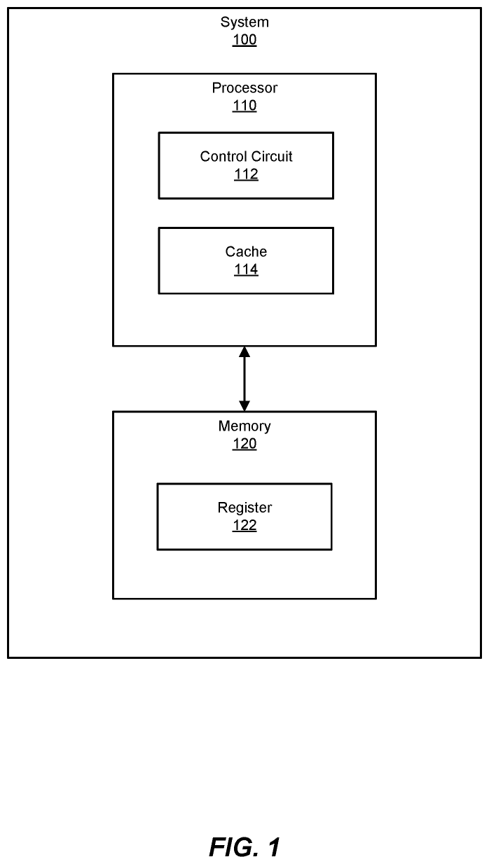

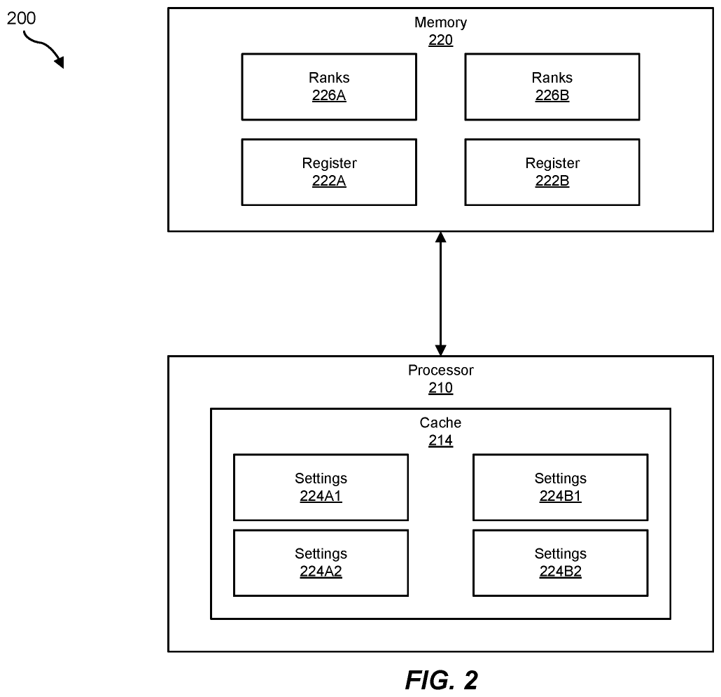

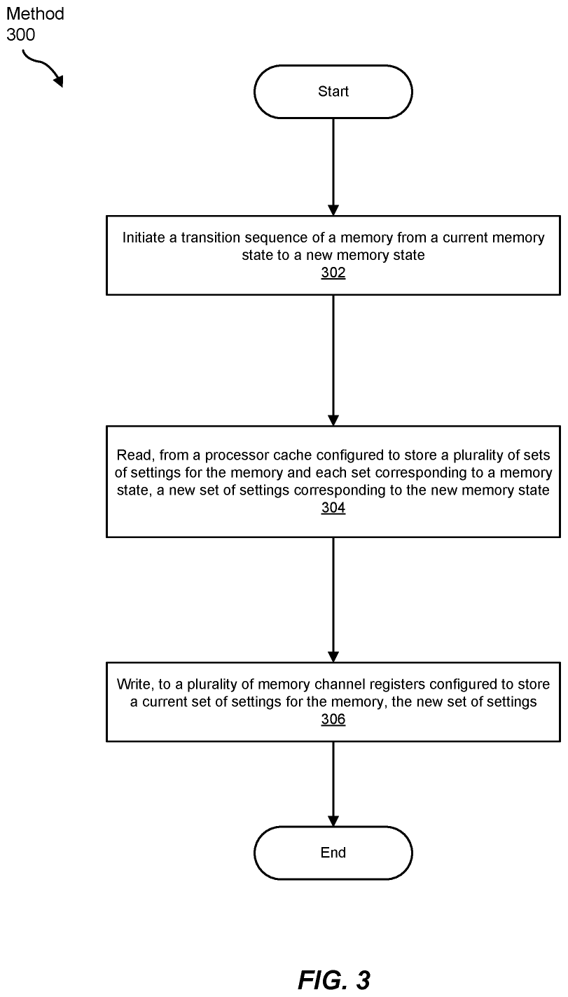

The following will provide, with reference to FIGS. 1-3, detailed descriptions of multiple memory performance states using system memory. Detailed descriptions of example systems for multiple memory performance states using system memory will be provided in connection with FIGS. 1 and 2. Detailed descriptions of corresponding computer-implemented methods will also be provided in connection with FIG. 3.

FIG. 1 is a block diagram of an example system 100 for multiple memory performance states using system memory. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110. Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, graphics processing units (GPUs), portions of one or more of the same, variations or combinations of one or more of the same, and/or any other suitable physical processor.

As further illustrated in FIG. 1, processor 110 includes a control circuit 112 and a cache 114. Control circuit 112 corresponds to one or more controllers or other circuitry that can manage memory state settings, such as swapping setting before memory state transitions as described herein. Cache 114 corresponds to a local storage (e.g., system memory) of processor 110 and can have space reserved for storing sets of memory state settings, as described herein.

In addition, memory 120 includes a register 122. Register 122 corresponds to a local storage of a memory controller for a memory channel for memory 120 and in some examples can correspond to multiple registers and/or sets of registers (e.g., for each memory channel of memory 120) which can store settings for a memory state. In some examples, register 122 can correspond to a memory operation (MOP) array. In some examples, a MOP array corresponds to a storage command buffer in a memory controller (e.g., DRAM controller), which can be loaded with various commands for configuration and memory functions, which can be pushed and/or executed one by one from the MOP array.

In some examples, memory 120 can operate in various memory states, each corresponding to a different clock or operating frequency. However, higher frequencies produces more potential for noise to be injected into signals, for example as write data signal noise. Techniques such as decision feedback equalization (DFE) can be tuned during training to cancel out or otherwise mitigate signal degradation due to noise on the write data signals. These techniques require tuning on each signal separately for each memory state, for instance during a boot sequence, to determine configuration settings and/or other frequency-dependent settings for cancelling noise at each trained frequency.

After the training, the settings can be stored in memory channel storage (e.g., register 122) to be accessed when transitioning to the corresponding memory state. However, an amount of values and a limited availability in storage often restricts training and storing settings for a single high performance state. The systems and methods described herein allow multiple high performance states by providing storage for multiple sets of settings.

FIG. 2 illustrates a system 200 that corresponds to system 100. System 200 includes a memory 220 that corresponds to memory 120 and a processor 210 that corresponds to processor 110. Memory 220 includes a register 222A and a register 222B, each corresponding to separate iterations of register 122 and each corresponding to one or more registers and/or data storage elements, along with ranks 226A and ranks 226B, each corresponding to various memory ranks which are organized into corresponding memory channels. Register 222A can correspond to local storage of a memory channel (e.g., A) for ranks 226A, and register 222B can correspond to local storage of a memory channel (e.g., B) for ranks 226B and can be used for storing sets of setting for a current memory state of memory 220.

Processor 210 includes a cache 214 that corresponds to cache 114. Cache 214 can store settings 224A1, settings 224A2, settings 224B1, and settings 224B2, each corresponding to sets of settings for memory states for memory channels (e.g., A and B described above). A control circuit (e.g., control circuit 112), can coordinate or facilitate memory 220 transitioning from a current memory state to a new memory state.

In some examples, the sets of settings are frequency-dependent settings corresponding to noise compensation settings (e.g., settings to compensate for write data signal noise), voltage settings, and/or timing settings. As described herein, the noise compensation settings and/or other settings can be tuned during training for each supported memory state during a boot sequence of system 200. The frequencies can correspond to different memory states such that the frequency-dependent settings can also correspond to memory states. When transitioning to a new memory state, memory 220 can use the settings stored in register 222A and register 222B for configuring the respective memory channels for the new memory state, if the settings correspond to the new memory state.

Before memory 220 transitions to the new memory state, the control circuit can, in some examples, initiate the transition or otherwise receive an indication of initiating the transition, and swap out values stored in register 222A and register 222B. For instance, the control circuit can read, from cache 214 in response to memory 220 transitioning to the new memory state, a new set of settings corresponding to the new memory state. As shown in FIG. 2, cache 214 can hold multiple sets of settings (for each channel) for multiple memory states. For example, settings 224A2 and settings 224B2 can correspond to the new memory state. The control circuit can accordingly select and read settings 224A2 and settings 224B2 from cache 214 and write the new settings to register 222A and register 222B, respectively.

In some examples, the control circuit can selectively write the new settings. For instance, some of the settings already stored in register 222A and/or register 222B can be the same as the new settings such that those particular settings do not require being rewritten, reducing a number of write operations to register 222A and/or register 222B. The control circuit can determine which settings of the current set of settings requires updating for the new set of settings. In some examples, the control circuit can compare the current settings stored in register 222A and/or register 222B with the new settings (e.g., settings 224A2 and/or settings 224B2) to determine which settings require updating. In some examples, the control circuit can compare the current settings as stored in cache 214. For instance, if settings 224A1 and/or settings 224A2 correspond to the current settings, the control circuit can compare the respect sets of settings as stored in cache 214, rather than reading from register 222A and/or register 222B. After determining the updated settings, the control circuit can write the updated settings to register 222A and/or register 222B. In some examples, the control circuit can write only the update settings, such as determining which locations within register 222A and/or register 222B to be updated such that locations and/or registers/data storage elements that are not updated can maintain their stored values.

The control circuit can swap the settings values as described herein during an initial phase of transition before register 222A and/or register 222B are read for configuring the respective memory channels. For example, the control circuit can write the new set of settings to register 222A and/or register 222B before a self-refresh operation phase of the transition initiates. In some examples, the control circuit can also send (e.g., before or as part of the self-refresh operation) commands to memory 220 that include the settings to be written, which in some examples also includes locations of the settings. In some examples, self-refresh mode allows a memory device (e.g., SDRAM) to retain data, even when the rest of the system is powered down, by not requiring external clocking. During a self-refresh operation, the memory device can adjust/update its own internal average periodic refresh interval as needed, for instance based on its own temperature sensor, without external control.

FIG. 3 is a flow diagram of an exemplary computer-implemented method 300 for multiple memory performance states using system memory. The steps shown in FIG. 3 can be performed by any suitable circuit, firmware, and/or computing system, including the system(s) illustrated in FIGS. 1 and/or 2. In one example, each of the steps shown in FIG. 3 represent an algorithm whose structure includes and/or is represented by multiple sub-steps, examples of which will be provided in greater detail below.

As illustrated in FIG. 3, at step 302 one or more of the systems described herein initiate a transition sequence of a memory from a current memory state to a new memory state. For example, control circuit 112 and/or memory 120 can initiate a transition sequence of memory 120 from a current memory state to a new memory state.

The systems described herein can perform step 302 in a variety of ways. In one example, control circuit 112 and/or memory 120 can detect a performance bottleneck with memory 120 and determine a higher performance state is desired to alleviate the bottleneck. In other examples, control circuit 112 and/or memory 120 can detect available memory bandwidth that a lower performance state would sufficiently manage while reducing power consumption. In yet other examples, control circuit 112 can detect and/or predict a change in workload and accordingly select a higher or lower performance state for memory 120. Moreover, in some implementations, control circuit 112 can receive an indication of memory 120 transitioning to the new memory state.

At step 304 one or more of the systems described herein read, from a processor cache configured to store a plurality of sets of settings for the memory and each set corresponding to a memory state, a new set of settings corresponding to the new memory state. For example, control circuit 112 can read, from cache 114, the new set of settings for the new memory state.

The systems described herein can perform step 304 in a variety of ways. In one example, control circuit 112 can select the appropriate set of settings for the new memory state from cache 114, which can hold sets of settings for multiple memory states.

At step 306 one or more of the systems described herein write, to a plurality of memory channel registers configured to store a current set of settings for the memory, the new set of settings. For example, control circuit 112 can write the new set of settings to register 122.

The systems described herein can perform step 306 in a variety of ways. In one example, control circuit 112 can write the new set of settings to the plurality of memory channel registers before a self-refresh operation of the transition sequence initiates. As further described herein, control circuit 112 can selectively write the new set of settings to register 122. Memory 120 can continue the transition process (e.g., perform the self-refresh operation), and accordingly configure itself for the new memory state using the settings available in register 122.

As detailed above, more unique physical layer (PHY) settings per performance memory states are needed as double data rate (DDR) speeds continue to increase. For instance, the settings required for DFE can be expensive in terms of register space/area and each DFE-enabled state can require per-state training of these settings. In some examples, the settings can only be updated through the memory controller MOP array during state transitions, and the MOP array is often not large enough to hold more than one state of DFE settings.

The systems and methods described herein allow DFE settings to be changed on a memory state transition through the MOP array. To limit the MOP array area cost, firmware and/or control circuitry can replace the contents of the MOP array with data stored in system SRAM depending on the memory state that is being transitioned to. This advantageously allows the use of existing generic SRAM space to effectively extend the MOP array without paying the area cost or altering the architecture.

As detailed above, the circuits, computing devices, and systems described and/or illustrated herein broadly represent any type or form of circuitry, computing device, and/or system capable of executing computer-readable instructions. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A device comprising:
a cache configured to store a plurality of sets of performance settings for memory, each set corresponding to a memory performance state operating at a memory frequency;
a plurality of registers configured to store a current set of performance settings for a current memory performance state of the memory; and
a control circuit configured to:
read, from the cache in response to the memory transitioning from the current memory performance state to a new memory performance state, a new set of performance settings corresponding to the new memory performance state; and
write, to the plurality of registers, the new set of performance settings.

2. The device of claim 1, wherein each of the plurality of sets of performance settings includes frequency-dependent settings.

3. The device of claim 2, wherein the frequency-dependent settings correspond to at least one of:
noise compensation settings;
voltage settings; or
timing settings.

4. The device of claim 3, wherein the noise compensation settings are tuned during a boot sequence of the device.

5. The device of claim 1, wherein a transition sequence for transitioning from the current memory performance state to the new memory performance state includes a self-refresh operation and the control circuit is configured to write the new set of performance settings to the plurality of registers before the self-refresh operation initiates.

6. The device of claim 1, wherein writing the new set of performance settings comprises selectively writing the new set of performance settings.

7. The device of claim 6, wherein selectively writing the new set of performance settings includes writing updated performance settings to corresponding registers of the plurality of registers for performance settings of the current set of performance settings that require updating for the new set of performance settings.

8. The device of claim 7, wherein selectively writing the new set of performance settings further comprises maintaining registers of the plurality of registers corresponding to performance settings that are not updated.

9. A system comprising:
a memory configured to operate at one of a plurality of memory performance states, each corresponding to a memory frequency;
a plurality of registers configured to store a current set of performance settings for a current memory performance state of the memory;
a processor including a cache configured to store a plurality of sets of performance settings for the memory, each set corresponding to one of the plurality of memory performance states; and
a control circuit configured to:
receive an indication of a transition sequence of the memory from the current memory performance state to a new memory performance state;
read, from the cache in response initiating the transition sequence, a new set of performance settings corresponding to the new memory performance state; and
write, to the plurality of registers, the new set of performance settings.

10. The system of claim 9, wherein each of the plurality of sets of performance settings includes frequency-dependent settings.

11. The system of claim 10, wherein the frequency-dependent settings correspond to at least one of:
noise compensation settings;
voltage settings; or
timing settings.

12. The system of claim 11, wherein the noise compensation settings are tuned during a boot sequence of the system.

13. The system of claim 9, wherein the transition sequence includes a self-refresh operation, and the control circuit is configured to write the new set of performance settings to the plurality of registers before the self-refresh operation initiates.

14. The system of claim 9, wherein the control circuit is configured to initiate the transition sequence in response to a power management decision.

15. The system of claim 9, wherein the plurality of registers corresponds to memory channel registers.

16. The system of claim 9, wherein writing the new set of performance settings comprises selectively writing the new set of settings.

17. The system of claim 16, wherein selectively writing the new set of performance settings includes writing updated performance settings to corresponding registers of the plurality of registers for performance settings of the current set of performance settings that require updating for the new set of performance settings.

18. The system of claim 17, wherein selectively writing the new set of performance settings further comprises maintaining registers of the plurality of registers corresponding to performance settings that are not updated.

19. A method comprising:
initiating a transition sequence of a memory from a current memory performance state operating a current memory frequency to a new memory performance state operating a new memory frequency;
reading, from a processor cache configured to store a plurality of sets of performance settings for the memory and each set corresponding to a memory performance state, a new set of performance settings corresponding to the new memory performance state; and
writing, to a plurality of memory channel registers configured to store a current set of performance settings for the memory, the new set of performance settings.

20. The method of claim 19, further comprising writing the new set of performance settings to the plurality of memory channel registers before a self-refresh operation of the transition sequence initiates.
